(19) United States
(12) Patent Application Publication
(10) Pub. No.: US 2014/0229246 A1
(43) Pub. Date: Aug. 14, 2014

(54) RFID Frequency Translator

(71) Applicant: Touraj Ghaffari, Boca Raton, FL (US)

(72) Inventor: Touraj Ghaffari, Boca Raton, FL (US)

(21) Appl. No.: 13/764,156

(22) Filed: Feb. 11, 2013

(51) Int. Cl. G06K 19/07

(52) U.S. Cl. CPC G06K 19/0723
USPC 705/13; 340/10.51

(57) ABSTRACT

An RFID-based system and method is disclosed which translates discrepant frequencies and protocols, for seamless communication across disparate devices. Any legal frequency is accepted, information transmitted in that frequency is translated then saved in allocated memory accessible to the other side, which receives and processes the information with an appropriate reader-equipped device such as cellphone, handheld device, or computer. HF for Near-Field Communication may be used as one frequency protocol, but is not limiting. A unique aspect is ability to power the translator at short range using the reader's field, eliminating a battery. A plurality of microcontrollers/memory modules is used. Microcontrollers receive information from one frequency interface by reading shared memory, then communicate to the other frequency interface by writing to its shared memory and signaling the presence of data. Microcontrollers monitor new data, await a response from the signaled interface, facilitating communication between two sides not otherwise in communication.

### FIELD OF THE INVENTION

The invention relates to the field of RFID communication and particularly to a system and method to bridge the discrepant frequencies used in that field for seamless communication.

### BACKGROUND OF THE INVENTION

In modern communication, especially logistical and access applications, those in environments involving identification or tracking of objects, radio frequency identification has become increasingly important. RFID chip tags have proliferated and are used to track and identify objects. The advent of diverse Smartphones and mobile devices, has introduced several new frequencies and protocols to the field. These devices have introduced complexities to already diverse RFID paradigms for tracking and identifying tagged objects, thus making the situation rather acute. Tagged objects often rely on Ultra High Frequency Protocols (a non-limiting example is an Electronic Product Code (EPC) chip using Class 1 Generation 2 UHF Air Interface Protocol Standard, commonly referred to as “EPC Class 1 Gen 2”). Tags associated with NFC (“Near-Field Communication”) handheld devices, on the other hand, need to be at a clear range of 6 to 20 inches. Handheld devices often rely on an NFC protocol, but newer devices have extended the NFC paradigm with mobile applications which require a longer read range, beyond one foot. NFC uses a much lower frequency range, e.g. a High Frequency Protocol (non-limiting examples of standards or protocol systems for 13.56 MHz communication include ISO/IEC 15693 standard for so called “vicinity cards” (up to 19 inches read range), ISO/IEC 14443 standard for so called proximity cards, ISO/IEC 18000-3—“Radio frequency identification for item management”). There is often little flexibility if mobile users within a broader environment need to read tagged objects situated at a farther location for purposes of tracking, identification, verification, or authentication of the objects or people carrying them. It is very difficult, expensive and uncommon to manufacture a handheld device capable of reading both NFC and UHF long-range RFID signals using a single reader. To the best extent of research, no existing system is practiced with this capability. The problem often encountered, then, is the occurrence of discrepant frequency bands in a single environment, where both frequency components are essential to the total equation.

There is therefore a long-standing need in the field of RFID, for a system to translate between the discrepant but essential frequency requirements in tracking and identification environments, which holds the key to an integrated and user-friendly paradigm. It is also desirable to create an energy efficient or self-powering RFID translation system which can draw its power merely from the energy field of an RFID reader in the vicinity.

The present invention bridges the communication gap between the various frequency bands such as VLF (Very Low Frequency such as 3 kHz to 30 kHz) HF (High Frequency—e.g. 13.56 MHz), VHF (Very High Frequency—between 30 MHz and 300 MHz), UHF (Ultra High Frequency—bands used include 860-960 MHz, “EPC Class 1 Gen 2” comprising standards, among others, of 862-870 MHz for Europe, 902-928 MHz for North America and 952-954 MHz for Japan, 433 MHz being covered by the ISO/IEC 18000-7 Standard; there are several other standards in item management applications), and SHF (Super High Frequency—e.g. 2.45 GHz, 5 GHz or 10 GHz), used in RFID communication through an RFID chip-based translator. HF frequency-based RFID systems have a very short read range (from 6-19 inches), do not require an unobstructed path between reader and tag (as is the case with, for example, an IR Barcode Scanner or optical device), and are commonly used with cell phones, handheld devices, or other mobile modalities, and UHF is typically used for a longer-range distance (typically up to 20 feet) and may be utilized for tracking and inventory control over a wider area. The present system is a translator between these (or any two) frequency bands. The RFID chip-based translator offers seamless communication of data and messages between differing frequency bands and protocols. RFID tags enable communication in situations such as, but not limited to, between devices like fixed or stationary readers, in inventory, manufacturing, verification, authentication or tracking applications, by protocols such as EPC Class 1 Gen 2 (UHF). RFID tags receive and transmit information which may be accessed by both frequencies (HF and UHF) and then retransmitted to other devices, particularly mobile type devices, or handheld readers by protocols involving HF frequencies such as 13.56 MHZ, through translators placed throughout the wider area.

### DESCRIPTION OF THE RELATED ART

Several patents, applications and publications deal with the subject of RFID technology and the existence of multiple protocols and frequencies, and underscore the lack and desirability of a unified standard; however, no patents offer a simple solution to the communication problem between higher frequency systems with a longer read-range and short range communication of NFC-enabled devices, sometimes deriving power from the NFC field of a reader.

U.S. Pat. No. 7,778,262 issued to Beagley et al. on Aug. 17, 2010, filed under US Patent Application US 2007/0183449 A1 on Sep. 6, 2006, discloses a Radio frequency multiple protocol bridge as an apparatus to interface with devices using different communication protocols, that scans a range of known frequencies for a communication protocol, then decode and translate the communication protocol into a common interface language. The apparatus used may include a pair of separate and co-located transceivers to accomplish the interface.

An article, “The Battle Between HF and UHF RFID”, by F. Mohd-Yasin, M. K. Khaw and F. Choong, of Multimedia University in Malaysia; and M.B.I. Reaz, of International Islamic University of Malaysia, dated May 15, 2008, published in Microwave Journal, Vol. 51, No. 5, May 2008, highlights and contrasts the respective advantages of using the two frequency bands, UHF and HF in the RFID field.

Likewise, the article “Designing a Crosspatch System to Interface between HFF and VHF Radios Using RSSI”, by Prabir Banerjee, Professor, and Rajorshee Raha, M. Tech Student, Department of Electronics and Communication Engineering, Heritage Institute of Technology, Kolkata, India, published in the International Journal of Information Systems and Communications, Vol. 1, No. 1, June 2011, deals with the tricky situation posed even by analog radio communication where different frequency bands are used.

What is obvious is that nobody has dealt with, let alone come up with an ingenious and relatively cost-effective way of bridging the gap in RFID based digital data communication posed by the existence of a plethora of frequency bands, industrial standards and protocols.

### SUMMARY OF THE INVENTION

The core invention described herein is directed to the adaptation of REID technology to systems for tracking, inventory management, verification, security and other tagging related applications, where varying frequencies of transmission used by RFID devices may be bridged in seamless data integration and translation so data may be read by discrepant frequency devices such as handheld devices and the like. A hardware based solution integrates circuitry for both frequency ranges and multiple read/write input/output memory modules to temporarily store tagged data.

It is one objective of the present system to translate from one to several other RFID communication frequencies. It is another objective to facilitate the reading of long-range RFID tagged information by a short range or NFC enabled device such as a mobile device. It is yet another objective to enable communication with both NFC and UHF signals using a single handheld device. It is yet another objective to power the system entirely using external power of the RFID field generated by an RFID frequency reader in communication with the system.

The present invention is directed to a system and method for communication between any two frequency-bands used in RFID communication. HF (High Frequency) and UHF (Ultra High Frequency) are often mentioned as examples but are not limiting. There are two components of the RF wave: magnetic and electric. Generally. HF RFID frequency, such as 13.56 MHz relies on the “near-field” magnetic aspect of the field, to energize a tag or code being read in order to elicit a response, while long range UHF RFID, such as 860-960 MHz exploits far-field radiation, consists of both electric and magnetic components. The UHF Class-1 Generation-2 air interface protocol V1.2.0 extends item-level tagging capabilities of UHF Class 1 Gen 2. The present system and method translates in the communication process between such varying frequencies. It may be used in various applications requiring translation between various radio-frequency communications. The present disclosure foresees the need for a communication between a stationary long-range reader and a short-range RFID tag system, such as using 13.56 MHz under ISO 15693, ISO 18000-3, or ISO/IEC 14443 standards.

The system provides for translation between, for example, HF and VHF, UHF or SHF frequency bands by means of passive, semi passive or active tags. Devices operating in these two bands of frequencies share memory with a dual interface micro controller. In an appropriate situation, the translator sources its power from the HF field generated by the RFID reader used in NFC, e.g., a 13.56 MHz RF field. This power feeds the micro-controller, which need not be power-intensive, and also multiple input/output read/write memory modules also having dual interfaces. Where for example, an HF chip is used, it will be in the field of the short range reader, and the device may derive a minimum of 1 volt of DC power or more depending on configuration. A dual-interface EEPROM will be sufficient for the input/output memory module, and can include password protection for data integrity and security. A long-range RFID reader, on the other hand, will communicate with the long-range RFID tag component, i.e. the long-range component subsystem of the translator, through a protocol such as EPC Class 1 Gen 2, and will transmit required information to the EPC chip. An indicator is now set to show when there is new data in user memory. The microcontroller then processes the data from the memory module associated with one frequency and then writes this data to the dual interface input/output memory module associated with the other frequency. The information from the memory module may then be transmitted from the system either to an ISO protocol-enabled smartphone or to a short-range RFID reader. The memory module also may be password protected or have similar security features for data and access integrity. The microprocessor always monitors for the presence of new data in the memory belonging to the side of either frequency protocol; once it receives the information, it then writes to the memory of the other frequency side, and tells it to send the data to that side using that frequency's RFID tag. The microcontroller always looks for a new data flag; the readers on either side may also check for the presence of a set flag or may set the flag for new data to be transferred. The microcontroller may also signal a host computer connected to the overall system through at least one of the external readers, of the fact that there are new data bytes in memory (setting a flag or data bit). The host may likewise read and write information to the memory module using its connected reader and one of the mentioned protocols. The microcontroller will monitor and send a signal to the RFID chip that there is newly written data for the system. Note that when used with a mobile or portable handheld device, the translator may be made small for portability and may take the form of either a sleeve around the mobile device, as a card which may be placed in a user's pocket in proximity of the mobile device, or as a flexible adhesive transfer to be affixed on the back of the mobile device. The translator works in conjunction with the mobile device as needed.

### BRIEF DESCRIPTION OF THE DRAWINGS

FIG. 1 is the basic concept of the translator between two RFID frequencies.

FIG. 2 is a high level view of the translator system and method and its component parts.

FIG. 3 is a Block Diagram which is a schematic representation of translation between RFID Tag HF and UHF frequencies through the use of a Semi Passive EPC chip with Dual Interface, a low powered microcontroller, and memory modules with Dual Interfaces.

FIG. 4 shows the translator working in conjunction with several UHF and SHF frequencies for seamless communication to a mobile device at an HF frequency.

FIG. 5 shows a Parking System based on RFID capability of a user's handheld device.

### DETAILED DESCRIPTION OF THE PREFERRED EMBODIMENTS

### Definitions

RFID—Radio Frequency Identification.
RFID Chip—RFID Silicon Wafer based Electronic Integrated Circuit
Tag/RFID Tag—An electronic identification device made up of a chip and antenna which exchanges data with an RFID reader through radio waves
Handheld Application—A software layer of System and processes which process the communication and information on a user's device such as handheld
Handheld Device—Any hand held user device which is portable for communication such as a mobile phone, PDA or tablet PC.
Flag—A ‘data’ bit which is set to ‘1’ to signalize the presence of new data to be read but which is set at ‘0’ by default
EPC Class 1 Gen 2—The Air Interface Protocol and Standard for Ultra High Frequency Radio-Wave Communication between an RFID Reader and the RFID) Module-based on passive-backscatter, Interrogator-talks-first (ITF), within the 860 MHz-960 MHz frequency range.

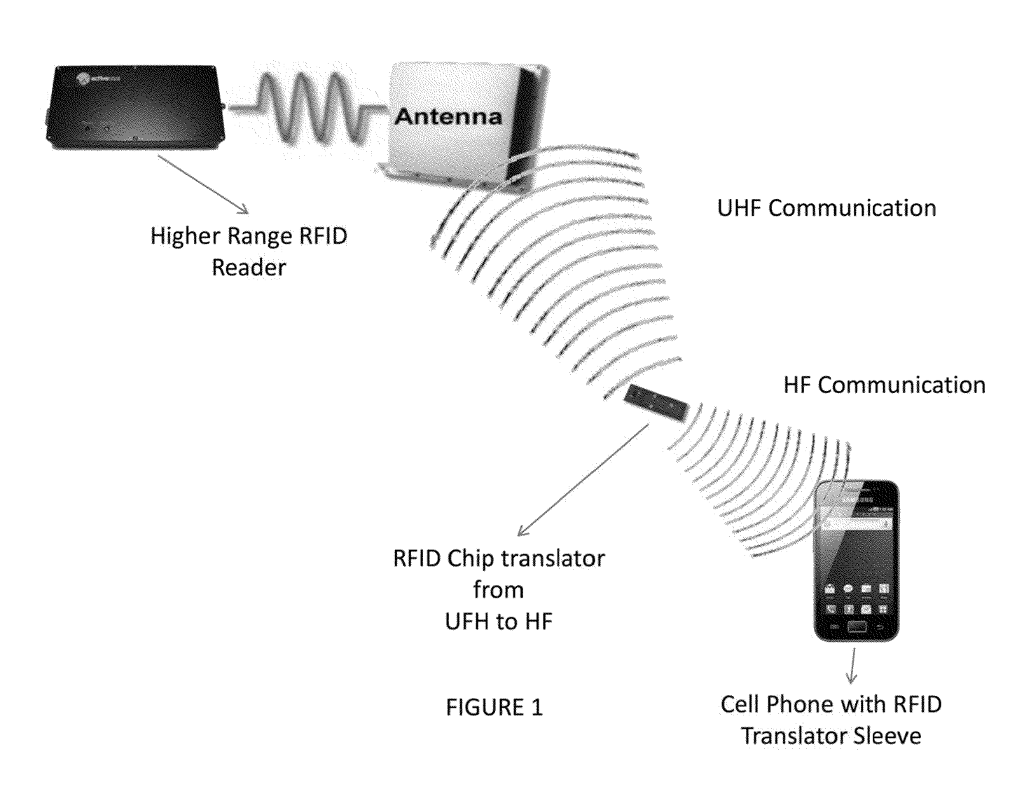

FIG. 1 shows the translator in operation between two RFID frequencies, UHF and HF. A UHF reader, through its antenna signals or awakens the translator chip to new communication, thus activating the RFID tag to broadcast and accept data from the UHF signal. This is then translated to the HF side which may take the form of a sleeve placed over a user's mobile phone.

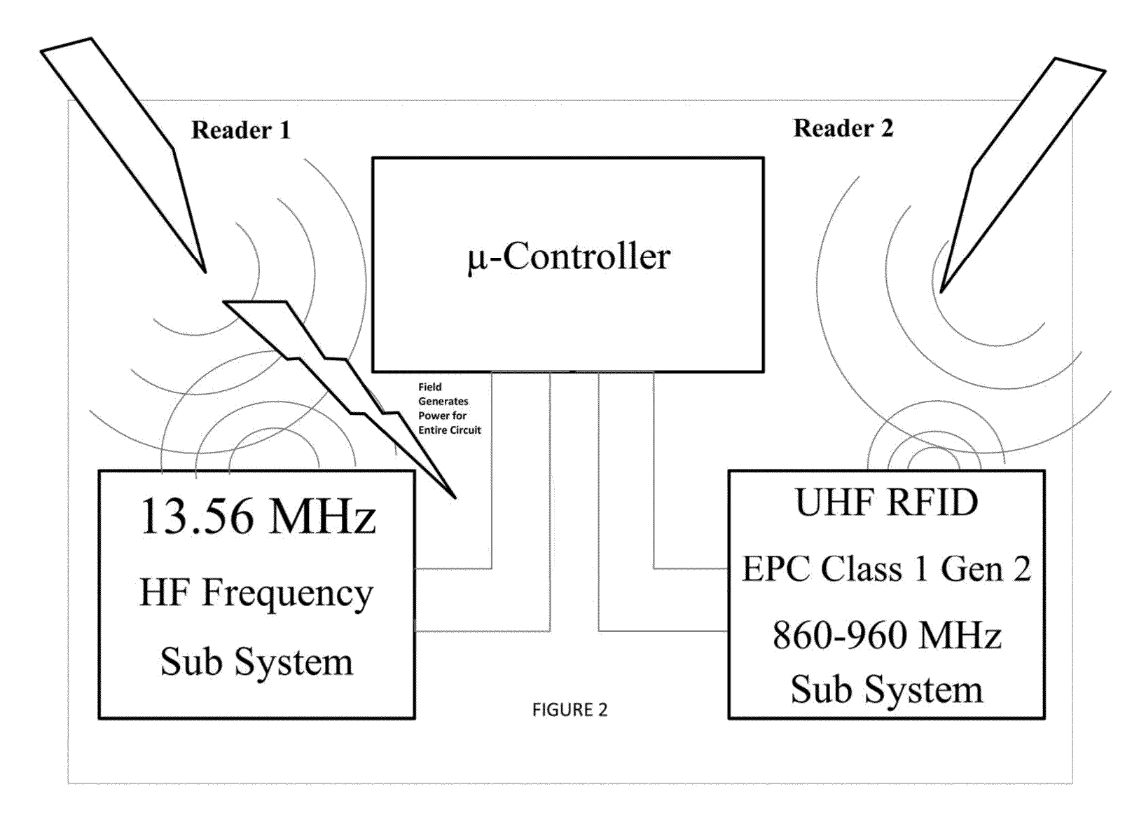

FIG. 2 breaks the translator up into its high level component parts. The microcontroller is basically linked with the tag system for either side. The Subsystems for either side, both the 13.56 MHz HF Frequency side, as well as the UHF RFID EPC Class 1 Gen 2 860-960 MHz side, are each in communication with their own RFID Reader and each side receives and sends information to the Reader after being awoken to a notification of new communication from the Reader. The generation of power for entire circuit is accomplished by the energy of the 13.56 MHz RFID HF frequency field.

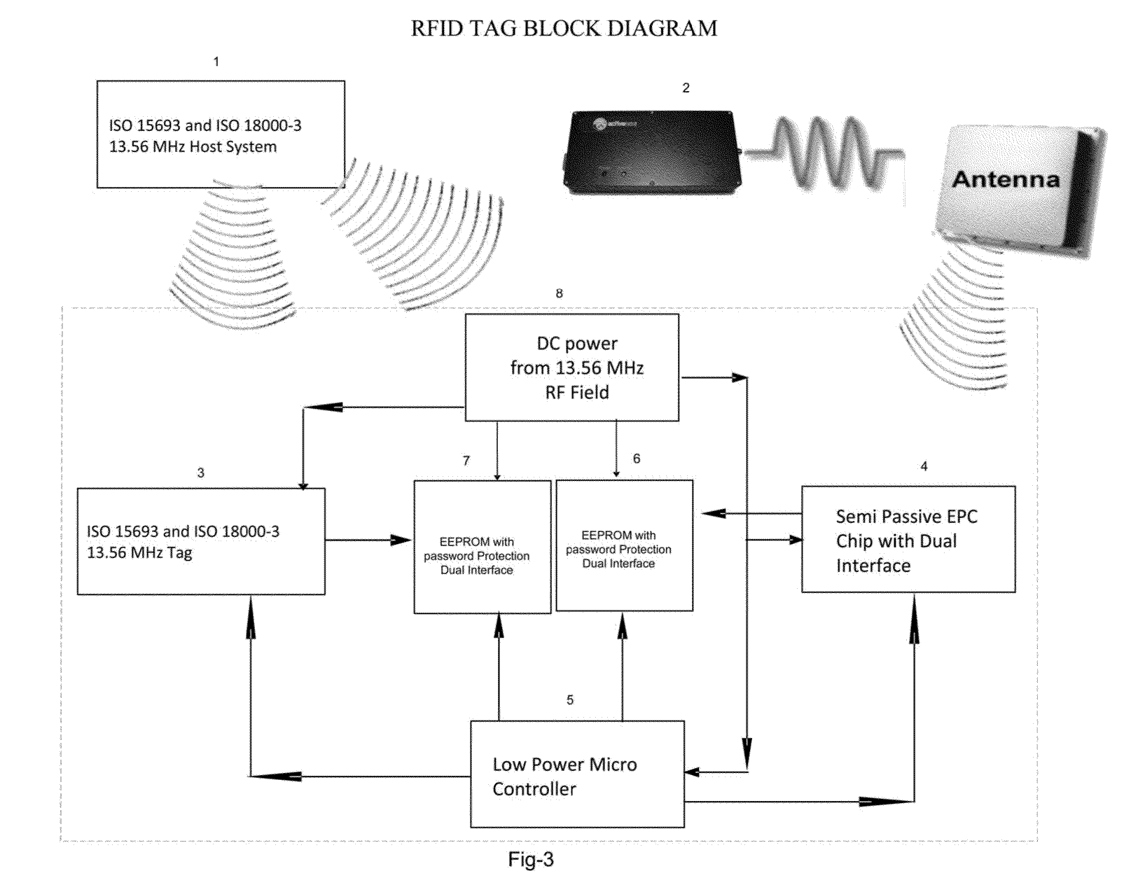

FIG. 3 is a Block Diagram which is a schematic representation of translation between RFID tag 3 HF and UHF frequencies 2 through the use of a single semi passive EPC chip 4 with dual interface, a low powered microcontroller 5, and dual memory modules 6 and 7 with dual interfaces, one per frequency subsystem. Dual Interface EEPROMs 6 and 7 with password protection may be chosen, as they are sufficient for the communication. The low-power microcontroller may comfortably derive its DC power 8 from the RFID HF frequency field of ISO 15693, ISO 18000-3, or ISO/IEC 14443 standard 13.56 MHz of the Host System Reader 1 used. This is optimally a minimum of 1V or more depending on the power configuration required. It is important to note that this configuration is merely illustrative and should not be construed as limiting of the invention.

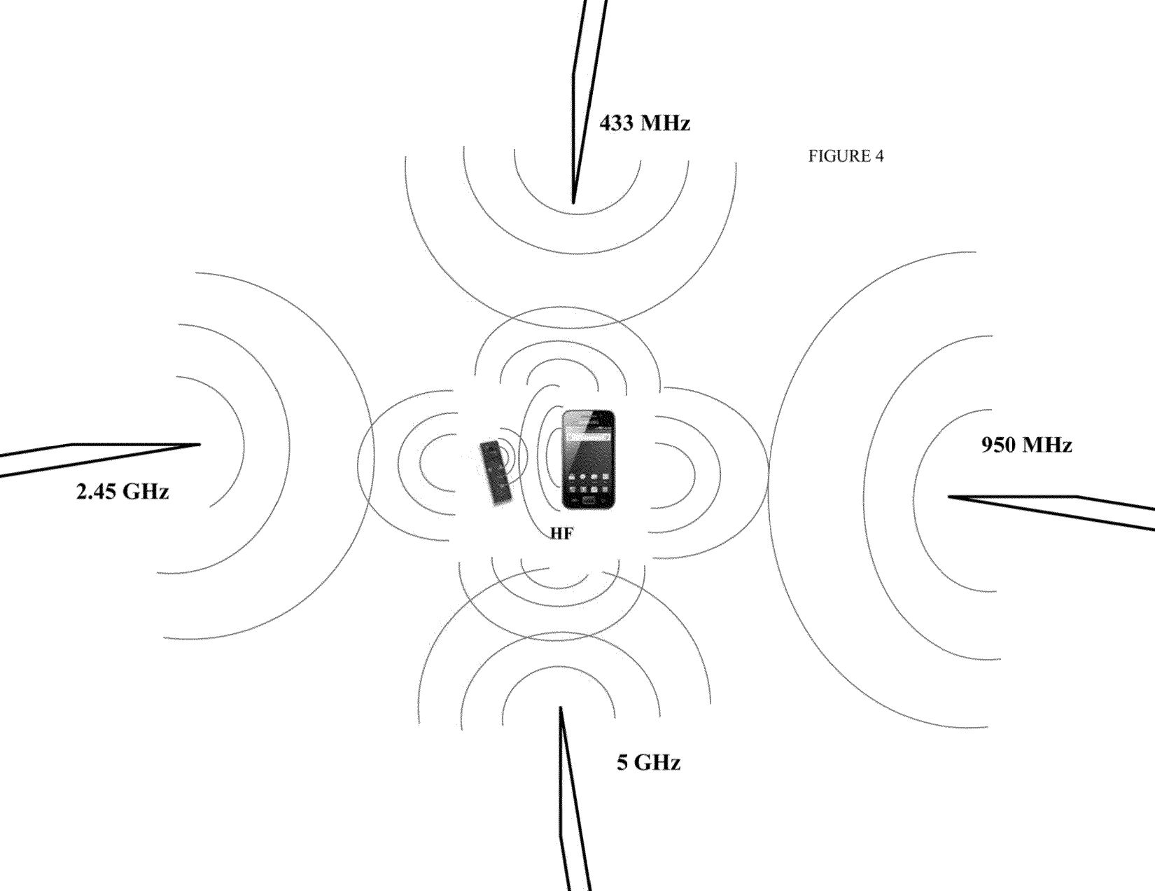

FIG. 4 shows the translator in a configuration enabled to work in conjunction with multiple UHF (433 MHz, (ISO 18000-7 compliant) and 950 MHz, EPC Class 1, Gen 2 used by Japan) and SHF (2.45 GHz or 5 GHz) frequencies for seamless communication to a mobile device operating at an HF frequency. These frequencies are only exemplary and not limiting.

The present invention provides an efficient automated system and method for managing payment-based parking using the translator. In accordance with an aspect of the present invention, a system for payment of parking, and access to a gate comprises any suitable verification device including an RFID unit connected through an IT network system to a suitable parking system server, where the server receives a message from a mobile device, the message including parking information received by the mobile device from the RFID unit as well as identification information for the mobile device, and locates an account in a client database based on the identification information provided, and charges the account the cost of garage stay, or on or off-street parking for a period of time or by parking event. The RFID unit, once notified that payment has been made sets either indicators of payment or time on a parking meter, or alternative may open a gate or access to a space. The translator is a bridge between the user's handheld device and the RFID unit which is connected to an indicator, display, access gate or timer as appropriate.

At the same time, a near field communication (NFC) payment system may provide for connectivity between mobile phones and physical objects such as those in an inventory. The system may enable people to interact with everyday objects through their mobile phone, and may streamline payment for parking.

### Three Usage Scenarios

The following scenarios describe useful but not limiting application of the translator system and method in a day-to-day situation.

### Usage Scenario 1—Car Park

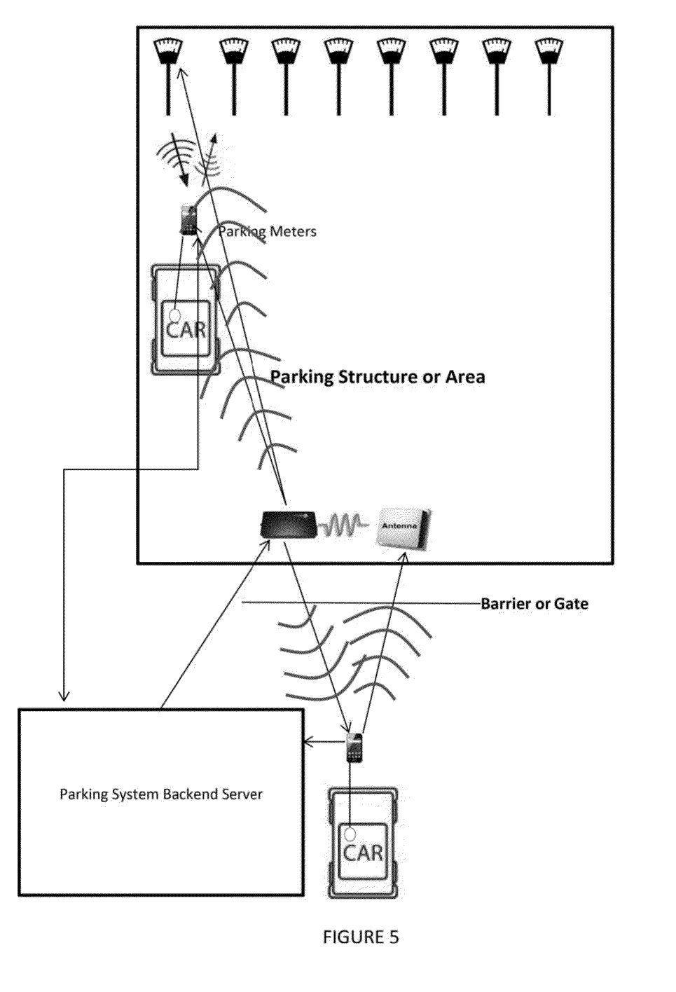

The user either has an appropriate Parking Application on his (her) Handheld running which (s)he then activates to signal arrival at a Car Park or else the user's handheld device has a background HF-based NFC process running which constantly polls the translator through 13.56 MHz Near-Field Communication for presence of data, particularly a bit set for indicating presence of data from a UHF source. The Gate of the Car Park is equipped with a detection sensor and a UHF-based RFID reader/signal. The UHF reader sends a signal to activate and wake up an active, semi-passive or passive tag on a translator unit used in conjunction with a handheld device of the user/driver. A UHF flag or bit is set in the translator memory signaling the availability of new data for the HF end, and the UHF reader also broadcasts its location to the translator, which is also placed in memory. The Handheld Application on the user's handheld device, which is awakened or started by the presence of the flag, now understands an appropriate flag has been set, meaning there is data to be read from the translator memory, essentially the Location ID of the Parking. Both Tag Number of the Translator/Phone Pair and Location ID of the Parking are sent by Handheld Application to a Backend Server for Verification. The Backend now sends a Confirmation Code to the Handheld Application which communicates this through the Translator Memory by NFC to the external RFID reader. Accordingly a flag is set in the translator that new data is present for the UHF reader. The reader scans the RFID tag on the UHF side for a flag that data is available to read from memory, the reader communicates with the tag, and the translator chip, now powered by the NFC field, transmits the data from memory to the reader, which is a Confirmation Code. The reader has already been equipped with all potential confirmation codes, so that it is now given the signal to open the gate of the parking lot. Alternatively, a different flag may be set in the translator so that there is merely passive communication from translator to reader if that flag is set, thus signaling only that the gate may be opened. The handheld can obtain the exact location of the parking lot using its GPS functionality or by checking the backend server for verification, then sending it to the backend host server this for verification to narrow down the search. Simultaneously, the backend server may also verify the user's account for confirmation of funds and payment for parking. FIG. 5 shows a car with its driver in RFID communication through a handheld device, in this case a mobile phone, with a gate access device of a parking structure. The backend server of a parking system communicates with the driver's handheld device, at the same time relaying information to the gate device or to a reader device in the vicinity. The car parked internally may communicate analogously through a driver's handheld device, with parking meters within the parking area. Optionally, when the driver enters the parking lot, the reader places a time stamp at the translator which is written to translator memory and to the application on the user's handheld device. The driver may choose to park in a particular space with parking meters. This scenario also works where there is merely street parking and no structure or lot. When the driver reaches a particular meter, (s)he may enter time for the stay into the application, which information goes to the long-range tag and may be read either by a much longer-range reader in the vicinity, or long-range reader in the parking meter. If an external longer-range reader is used, it may communicate with a tag in the parking meter to write the time for the driver's stay to an RFID tag in the parking spot associated with that meter. Otherwise, the meter itself is involved in RFID communication with the driver's phone. This is illustrated in the internal example of FIG. 5.

### Usage Scenario 2—User Enters a Store

The user either has an appropriate Handheld Shopping Application running which (s)he then activates to signal arrival at a Department Store, or else the user's handheld device has a background HF-based NFC process running which constantly polls the translator through 13.56 MHz Near-Field Communication for presence of data, particularly a bit set for indicating presence of new data from a UHF source. The Entrance Doors to the Department Store are equipped with a detection sensor and UHF-based RFID reader/signal. The UHF reader sends a signal which activates and awakens an active, semi-passive or passive tag on a translator unit which is in physical and logical conjunction with a handheld device of the user. A translator UHF flag or bit is set, to signalize the presence of new data to be read by the HF side of the system, and the reader also broadcasts the location of the store to the translator which is also placed in the translator's memory. The Handheld Application on the user's handheld device, which is awakened or started by the presence of the flag, constantly polling the translator through the 13.56 MHz Near-Field Communication, understands that an appropriate flag was set, meaning there is data to be read from the memory in the translator, essentially Store Location. Both Tag Number of the Translator/Phone Pair and Store Location are sent by the Handheld Application to a Backend Server for Verification. The Backend Server now sends a Communication to the Handheld Application or a Text Message to the Phone itself, which communicates this through the Translator Read/Write Memory again by NFC to the UHF Reader. Accordingly a flag is set in the translator that data is present for the UHF reader. The reader scans the RFID tag for a flag in the translator that data is now available to read from memory, the reader communicates with the tag, and the semi-passive chip on the translator, powered by the NFC, transmits data from the memory to the Reader, i.e. the User's ID. A reader may be wired to other devices like a Server within the store, or to a message system at the door, that may greet the user by name. A possible further use of long-range UHF communication is the tracking of inventory within the store for the user, where a (s)he is prompted for a class or genre of product desired from the store's inventory. The backend server application then sends a message to UHF RFID devices within the store to search all RFID-tagged objects for the type of product sought (e.g. ‘blue shirt’ or ‘USB cable’). This is typically accomplished through a Wi-Fi type network in the store permanently connected to the back-end application. When matching objects are found through the database, the user is sent a message with locations of the tagged objects. In particular, UHF long-range devices send a notification to the translator and place the locations within the store in the memory of the translator which is then conveyed to the handheld application through the translation method. Alternatively, a message is entirely generated by the backend server which contains a tracking-map database of inventory within the store preloaded and updated in real time by a UHF RFID tracking application running in the store by means of RFID-tagged inventory and multiple UHF long-range devices placed throughout the store.

### Usage Scenario 3—User Exits a Restaurant and Approaches a Valet

The user either has an appropriate Handheld-based Restaurant and Valet Application running, which (s)he then activates to signal arrival at a Restaurant Valet, or else the user's handheld device has a background HF-based NFC process running which constantly polls the translator through 13.56 MHz Near-Field Communication for presence of data, particularly a bit set to indicate presence of new data from a UHF source. The user approaches a UHF reader on the Entrance/Exit Door of a Restaurant equipped with a detection sensor and a UHF-based RFID Reader. The Reader sends a signal to activate and awaken an active, semi-passive or passive tag on a translator unit in Near-Field Communication (HF-based) with the user's handheld device. A UHF flag or bit is set in the translator, to signify presence of data to be read by the HF-enabled handheld device, and the reader also broadcasts the Restaurant ID to the translator, which is accordingly placed in the HF side memory module of the Translator. The Handheld Application on the user's handheld device, awakened or started by the presence of the flag, constantly polls the translator through 13.56 MHz Near-Field Communication, then understands an appropriate flag was set, meaning that data is ready to be read from the memory in the translator, which in this case is the Restaurant ID. The Translator Tag Number and the User's as well as Restaurant Identification are all communicated to a backend application server over the user's mobile network. This sends a message to a queue system placed at the Valet desk for the Valets to then deliver the user's car to the front of the restaurant. A Restaurant Menu may be optionally popped-up on the user's handheld device when (s)he first enters the Restaurant. Specific applications using an inventory management solution analogous to the product search option laid out in Usage Scenario 2 above which can search out a user's desired wines by tagged bottle.

It is to be understood that the configuration of the present system and method shown herein is merely illustrative and should in no way be construed as limiting of the invention. All suitable modifications are permissible and covered within the scope of the claimed invention.

I claim:

1. A system for translation between a plurality of frequencies in RFID data communication, comprising:
a plurality of RFID-equipped tags, each operating at a different RFID frequency protocol to communicate to an external RFID reader also operating at that same RFID frequency protocol;
a plurality of dual interface central processing units each coupled to at least two RFID-equipped tags; and
a plurality of readable and writable memory modules, each module coupled to at least one of the dual interface central processing units as well as to at least one of the RFID-equipped tags;
wherein at least one memory module coupled to each of the RFID-equipped tags stores data transmitted by or received by that RFID-equipped tag from RFID-communication with an external RFID reader also operating at that same RFID frequency protocol;
wherein each readable and writable memory module has a flag bit to be set to signalize the presence of new data in the readable and writable memory module;
and wherein data from the at least one readable and writable memory module is written to at least one other memory module coupled to another of the RFID-equipped tags, so as to communicate this data from that RFID-equipped tag by RFID-communication to another external RFID reader also operating at the same RFID frequency protocol.

2. The system of claim 1, which may operate using power generated entirely from a frequency field around one of the external RFID readers.

3. The system of claim 1, which may operate using power from an attached battery.

4. The system of claim 1, wherein at least one external reader is coupled to a data communication network and server.

5. The system of claim 4, wherein the data communication network and server run a validation and transaction processing or inventory tracking application.

6. The system of claim 5, wherein at least one of the external RFID readers communicate to an access regulating mechanism of a car parking system, and the validation and transaction processing application run by the data communication network and server processes transactions related to parking payment.

7. The system of claim 1, wherein at least one of the external RFID readers communicate to external objects in a spatial environment in order to track the location and identification of the external objects in order to relay this information to the system for further communication and translation.

8. The system of claim 1, packaged thinly as a card structure.

9. The system of claim 1, embedded into the sleeve of a user's mobile device.

10. The system of claim 1, manufactured in a thin flexible form which can be transformed into an adhesive transfer for the user's mobile device.

11. A method for translation between a plurality of frequencies in RFID data communication, comprising the steps of:
communicating by a plurality of RFID-equipped tags each to a specific external RFID reader by means of a specific RFID frequency protocol;
coupling each of the plurality of the RFID-equipped tags to at least one of a plurality of dual interface central processing units;
coupling each of a plurality of readable and writable memory modules to at least one of the dual interface central processing units as well as to at least one of the RFID-equipped tags;
coupling each of the plurality of dual interface central processing units to at least two RFID-equipped tags, each through at least one readable and writable memory module;
relaying information from an external RFID reader to at least one RFID-equipped tag by means of a specific RFID frequency protocol;
writing the information from the at least one RFID-equipped tag to at least one of the readable and writable memory modules coupled to that RFID-equipped tag;
reading the information by at least one of the dual interface central processing units coupled to the at least one readable and writable memory modules just written to;
processing of the information by at least one of the dual interface central processing units;
writing the processed information to at least one other readable and writable memory module coupled to at least one other RFID-equipped tag;
signaling the presence of the new processed information for the at least one other RFID-equipped tag by setting a flag bit in the at least one just written memory module; and
relaying the processed information to at least one other external RFID reader from the at least one other RFID-equipped tag by means of at least one other RFID frequency protocol.

12. The method of claim 11, further comprising the step of generating power for the plurality of dual interface central processing units as well as the plurality of readable and writable memory modules entirely from a frequency field around one of the external RFID readers.

13. The method of claim 11, further comprising the step of using power for the plurality of dual interface central processing units as well as the plurality of readable and writable memory modules from an attached battery.

14. The method of claim 11, further comprising the step of coupling e wherein at least one external reader to a data communication network and server to process transmitted data.

15. The method of claim 14, wherein the data communication network and server run a validation and transaction processing or inventory tracking application.

16. The method of claim 15, wherein at least one of the external RFID readers communicate to an access regulating mechanism of a car parking system, and the validation and transaction processing application run by the data communication network and server processes transactions related to parking payment.

17. The method of claim 11, further comprising the step of communicating by at least one external RFID reader to external RFID-tagged objects in a spatial environment in order to track the location and identification of the external RFID-tagged objects and relay this to the at least one RFID-equipped tag for further communication and translation.

18. The method of claim 11, further comprising the step of packaging the plurality of RFID-equipped tags, the plurality of readable and writable memory modules and the plurality of dual interface central processing units into a single thin card structure.

19. The method of claim 11, further comprising the step of embedding the plurality of RFID-equipped tags, the plurality of readable and writable memory modules, as well as the plurality of dual interface central processing units into the sleeve of a user's mobile device.

20. The method of claim 11, further comprising the step of assembling the plurality of RFID-equipped tag, the plurality of readable and writable memory modules as well as the plurality of dual interface central processing units into a thin flexible form which can be turned into an adhesive transfer for the user's mobile device.
